(19) United States
(12) Patent Application Publication
(10) Pub. No.: US 2013/0243391 A1
(43) Pub. Date: Sep. 19, 2013

(54) METHOD AND APPARATUS FOR CREATING A MEDIA FILE FOR MULTILAYER IMAGES IN A MULTIMEDIA SYSTEM, AND MEDIA-FILE-REPRODUCING APPARATUS USING SAME

(71) Applicants: Pil-Kyu Park, Seoul (KR); Dae-Hee Kim, Suwon-si (KR); Dae-Sung Cho, Seoul (KR)

(72) Inventors: Pil-Kyu Park, Seoul (KR); Dae-Hee Kim, Suwon-si (KR); Dae-Sung Cho, Seoul (KR)

(73) Assignee: SAMSUNG ELECTRONICS CO., LTD., Suwon-si, Gyeonggi-do (KR)

(21) Appl. No.: 13/989,214

(22) PCT Filed: Nov. 23, 2011
(86) PCT No.: PCT/KR2011/009001

§ 371 Date: May 23, 2013

Related U.S. Application Data
(60) Provisional application No. 61/416,391, filed on Nov. 23, 2010.
(60) Provisional application No. 61/417,995, filed on Nov. 30, 2010.

(51) Int. Cl. H04N 9/87

(52) U.S. Cl. CPC H04N 9/87
USPC 386/230; 386/241

(57) ABSTRACT

The present invention relates to a method and apparatus for creating a media file for multilayer images. The method for creating a media file for multilayer images in a multimedia system according to one embodiment of the present invention comprises the following processes: encoding input images to generate bit streams of multilayer images; and taking, as an input, bit streams of the multilayer images, and creating a media file including a plurality of pieces of track information divided into a base layer and at least one enhancement layer, and media data for images of each layer.

### CROSS REFERENCE TO RELATED APPLICATIONS

This application is a National Stage application under 35 U.S.C. §371 of International Application No. PCT/KR2011/009001 filed on Nov. 23, 2011, and claims the benefit U.S. Provisional Application No. 61/416,391 filed on Nov. 23, 2010 and U.S. Provisional Application No. 61/417,995 filed on Nov. 30, 2010 in the U.S. Patent and Trademark Office, the entire disclosures of which is hereby incorporated by reference.

### BACKGROUND

1. Technical Field

The present invention relates to a method and an apparatus for generating a media file, and more particularly to a method and an apparatus for generating a media file for multilayer videos.

2. Background Art

Multilayer video encoding/decoding has been proposed to satisfy many different Qualities of Service (QoS) determined by various bandwidths of a network, various decoding capabilities of devices, and user's control. That is, an encoder generates layered multilayer video bitstreams through once encoding, and a decoder decodes the multilayer video bitstreams according to its decoding capability. Temporal and spatial Signal-to-Noise Ratio (SNR) layer encoding can be achieved, and multilayer encoding is available depending on an application scenario.

However, the conventional multilayer video encoding/decoding method using the correlation between a base layer bitstream and an enhancement layer bitstream in multilayer videos has high complexity, and its complexity depends on the features of the encoding/decoding of a base layer encoder/decoder. Therefore, the complexity is significantly increased when the conventional multilayer video encoding/decoding method generates the multilayer videos. Accordingly, a method of efficiently encoding/decoding multilayer videos has been demanded.

A representative example of a file format of the encoded video is a format of an ISO base media file regulated under ISO/IEC (hereinafter, referred to as the “ISO base file”). Further, the ISO base media file is generally called a media file. The format of the media file is a standard file format used for multimedia services and serves as a basis of a flexible and expandable media file structure.

FIG. 1A is a diagram schematically illustrating a format of a general ISO base file 100a. Referring to FIG. 1A, in the ISO base file 100a, information and functions necessary for reproducing a plurality of media contents are configured in a box form based on an object.

In FIG. 1A, the ISO base file 100a includes a movie box (moov box) 110 and a media data box (mdat box) 130. The movie box 110 stores spatial and temporal location information and codec information for media data stored in the media data box 130. The media data box 130 stores media data (or media stream), such as video and audio. The movie box 110 contains information on how to construct media data, such as video data, audio data, text data, and image data, within a single scene.

Tracks (trak) 111 and 113 in the movie box 110 contain basic information and information on a reproduction method of corresponding media data. Further, the track 111 in FIG. 1A contains information on video data and track 113 contains information on audio data. Media data corresponding to each of the tracks 111 and 113 is defined with a set of temporally sequential samples in the ISO base file 100a. Accordingly, the media data corresponds to sequential video samples or sequential audio samples.

However, the ISO base file 100a of FIG. 1A is proposed as a standard file format for the general multimedia services and does not support multilayer videos. In this respect, a media file format appropriate for multilayer videos has been demanded.

### SUMMARY

The present invention provides a method and an apparatus for generating a media file for multilayer videos in a multimedia system.

Further, the present invention provides a recording medium storing a media file for multilayer videos in a multimedia system.

Furthermore, the present invention provides a terminal apparatus for reproducing a media file for multilayer videos in a multimedia system.

In accordance with an aspect of the present invention, there is provided a method of generating a media file for multilayer videos in a multimedia system, the method including: encoding an input video and generating bitstreams of multilayer videos; and receiving the bitstreams of the multilayer videos and generating a media file including information on multiple tracks, which are divided into a base layer and one or more enhancement layers, and media data of a video of each layer.

In accordance with another aspect of the present invention, there is provided an apparatus for generating a media file for multilayer videos in a multimedia system, the apparatus including: an encoder for encoding an input video and generating bitstreams of multilayer videos; and a file generator for receiving the bitstreams of the multilayer videos and generating a media file including information on multiple tracks, which are divided into a base layer and one or more enhancement layers, and media data of a video of each layer.

In accordance with another aspect of the present invention, there is provided a terminal apparatus for reproducing a media file in a multimedia system, the terminal including: a display unit for displaying a media file; a decoder for decoding multilayer videos including a base layer and one or more enhancement layers; and a controller for making a control such that a media file including information on multiple tracks of the multilayer videos and media data of a video of each layer is analyzed, at least one layer video is extracted, the extracted layer video is restored in the decoder, and the restored layer video is displayed through the display unit.

### BRIEF DESCRIPTION OF THE DRAWINGS

FIG. 1A is a diagram schematically illustrating a format of a general ISO base file 100a;

FIG. 1B is a diagram schematically illustrating a format of an ISO base file 100b according to an embodiment of the present invention;

FIG. 2 is a diagram illustrating a multilayer video encoding device according to an embodiment of the present invention;

FIG. 3 is a diagram illustrating a media file generating device for multilayer videos according to an embodiment of the present invention;

FIG. 4 is a diagram illustrating a multilayer video decoding device according to an embodiment of the present invention;

FIG. 5 is a diagram illustrating a media file reproducing device for multilayer videos according to an embodiment of the present invention;

FIG. 6 is a diagram specifically illustrating a format of a media file according to an embodiment of the present invention;

FIG. 7 is a diagram specifically illustrating a format of a media file according to another embodiment of the present invention; and

FIG. 8 is a diagram illustrating an example of a movie box (moov box) in a media file according to another embodiment of the present invention.

### DETAILED DESCRIPTION

In the following description, detailed explanation of known related functions and constitutions may be omitted so as to avoid unnecessarily obscuring the subject manner of the present invention. Hereinafter, exemplary embodiments of the present invention will be described with reference to the accompanying drawings.

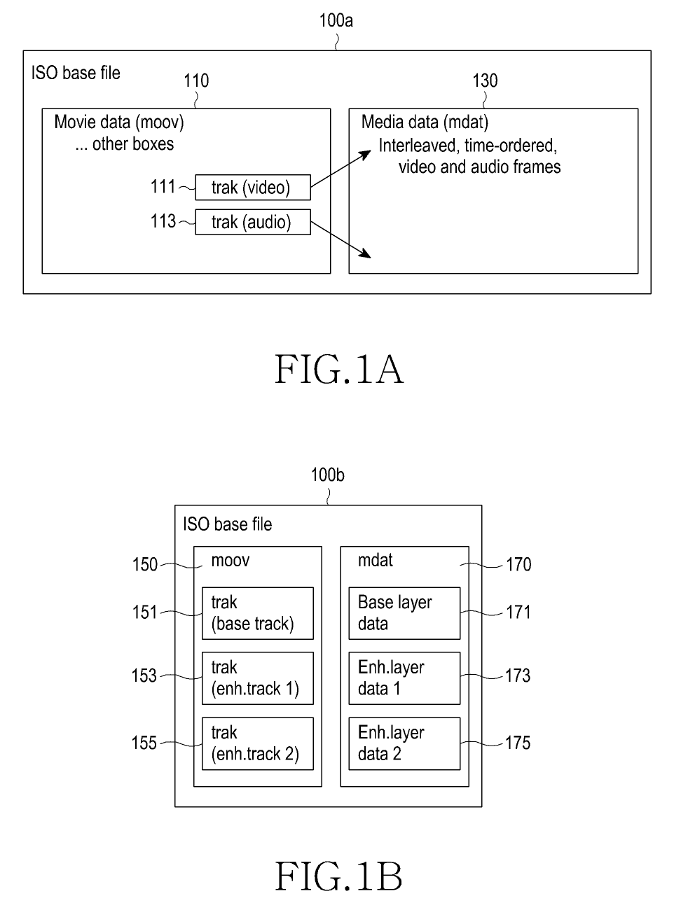

FIG. 1B is a diagram schematically illustrating a format of an ISO base file 100b according to an embodiment of the present invention. Referring to FIG. 1B, in the ISO base file 100b, information and functions necessary for reproduction of media data corresponding to one or multi layer videos are configured in a box form based on an object.

In FIG. 1B, the ISO base file 100b includes a movie box (moov box) 150 and a media data box (mdat box) 170. The movie box 150 stores temporal and spatial location information and codec information on media data stored in the media data box 170. The media data box 170 stores media data (or media stream), such as video data and audio data. The movie box 170 contains information on how to construct media data, such as video data, audio data, text data, and image data, within a single scene. That is, the information stored in the movie box 170 corresponds to header information necessary for reproducing the media data stored in the media data box 170, and tracks (trak) 151, 153, and 155 in the movie box 150 contain basic information and information on a reproducing method of corresponding media data.

The ISO base file 100b according to the embodiment of the present invention supports multilayer videos. The multilayer videos include a base layer video and at least one enhancement layer video. The base layer video refers to a video having a low resolution, a small size, or one view point, and the enhancement layer video refers to a video having a higher resolution or a larger size than that of the base layer video, or a view point different from that of the base layer video.

FIG. 1B illustrates an example of the format of the ISO base file 100b supporting a single base layer video and two enhancement layer videos for convenience's sake, but one or multi enhancement layer videos may be supported.

Accordingly, the base track 151 for the base layer video in the movie box 110 contains basic information and information on a reproduction method of the base layer video. Further, the enhancement tracks 153 and 155 for the enhancement layer video in the movie box 110 contain basic information and information on a reproduction method of a corresponding enhancement layer video. Here, the basic information is information on a frame rate, a bit rate, and a video size of the basic layer video or the enhancement layer video. The information on the reproduction method is various information for reproducing each layer video, such as synchronization information for supporting a reproduction function.

The base track 151 contains only information on the base layer video, and each of the enhancement tracks 153 and 155 may contain information on at least one different enhancement video together with information on a corresponding enhancement layer video except for the base track 151. The base track 151 and all boxes included in the base box 151 conform to formats defined in the ISO base file format compatible with a codec used in the base layer, the media data (base layer data), and a corresponding file format. Accordingly, if a reproduction device, which does not support the media file format according to the present invention, supports the ISO file format of a codec used in a base layer, media data in the base layer may be reproduced.

Further, the media data box 170 of the ISO base file 100b of FIG. 1B stores media data (or media stream), such as video data and audio data. FIG. 1B illustrates an example in which a bitstream 171 of the base layer video and two bitstreams 173 and 175 of the enhancement layer video are divided into each layer data to be stored.

Hereinafter, a multilayer video encoding/decoding apparatus, to which the media file, i.e. the ISO base file 100b having the aforementioned structure, of the present invention is applied, will be described.

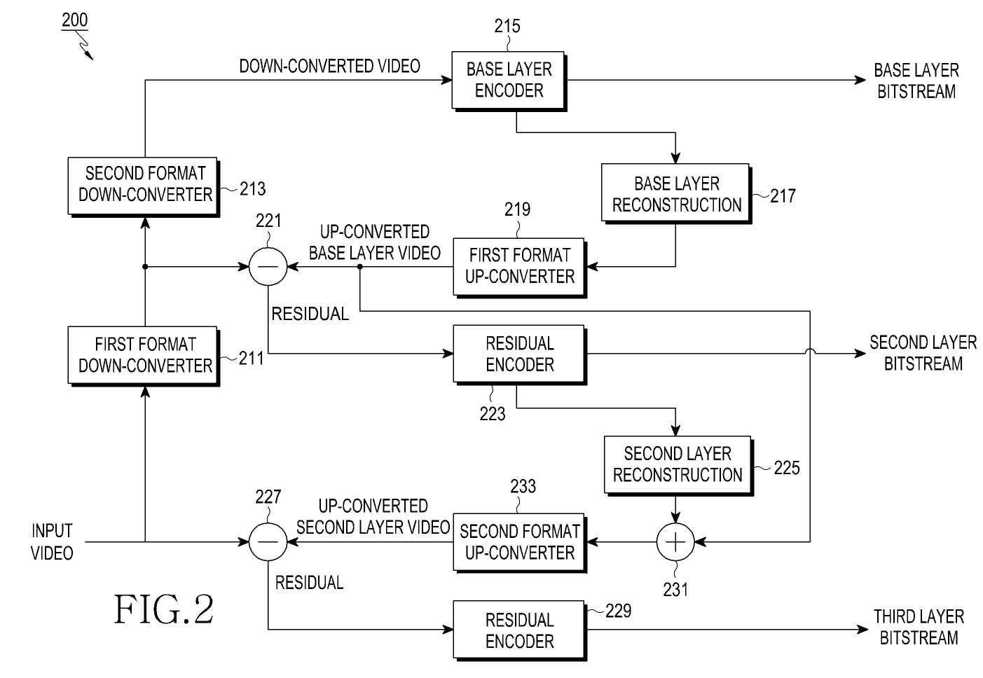

FIG. 2 is a diagram illustrating a multilayer video encoding device according to an embodiment of the present invention, and illustrates an example of a construction of a video encoding device for encoding three layer videos including one base layer video and two enhancement layer videos. However, the present invention is not limited to the encoding device of FIG. 2, and the media file of the present invention may be applied to multilayer videos including at least two layers.

In the embodiment of FIG. 2, an original input video is twice down-converted for a layer encoding of three layers. Through the process, two layer videos are generated from the original input video. It is assumed in the embodiment of FIG. 2 that the twice down-converted video is a base layer video, the once down-converted video is a second layer video, and the original input video is a third layer video.

The encoding device of FIG. 2 generates a base layer bitstream by using an existing standard video codec. Further, the encoding device of FIG. 2 restores the base layer bitstream and encodes a residual video which is a difference between the base layer video which has been format up-converted and the second layer video, to generate a second layer bitstream. Further, the encoding device of FIG. 2 restores the second layer video, synthesizes the restored second layer video with the video format up-converted in the base layer, and encodes a residual video which is a difference between the video which has been format up-converted and the original input video which is the third layer video, to generate a third layer bitstream.

A process of the encoding will be described with reference to FIG. 2 in detail.

The encoding device in FIG. 2 sequentially down-converts the input video through a first format down converter 211 and a second format down converter. Through the process, two videos are generated from the original input video. The video obtained through twice down-converting the input video, i.e. the video output from the second format down converter 213, is the base layer video. The video obtained through once down-converting the input video, i.e. the video output from the first format down converter 211, is the second layer video. The input video is the third layer video. A base layer encoder 215 in FIG. 2 encodes the base layer video to generate the base layer bitstream. The base layer encoder 215 may use an existing standard video codec, such as VC-1, H.264, MPEG-2, and MPEG-4.

A residual encoder 223 encodes the residual video to generate the second layer bitstream. The residual video means a difference between the video which has been format up-converted and the second layer video after the restoration of the base layer video. A base layer restorer 217 restores the base layer video, and the restored base layer video is format up-converted in the first format up-converter 219. A first residual unit 221 calculates a difference between the video obtained through the format up-conversion, i.e. the up-converted base layer video, and the second layer video to output the residual.

A second layer restorer 225 in FIG. 2 restores the second layer video from the output of the residual encoder 223. The restored second layer video is combined with the output video of the first format up-converter 219 in a combiner 231. The output video of the combiner 231 is format up-converted in the second format up-converter 233. A second residual unit 227 calculates a difference between the video obtained through the format up-conversion, i.e. the up-converted second layer video, and the input video which is the third layer video, to output a residual. A residual encoder 229 encodes a residual video output from the second residual unit 227, to generate the third layer bitstream.

In the embodiment of FIG. 2, the example of the construction of the encoding apparatus for encoding the multilayer videos including the base layer video, the second layer video, and the third layer video and outputting the bitstream corresponding to each layer has been described. However, the multilayer bitstreams including at least two layers may be generated through the aforementioned method.

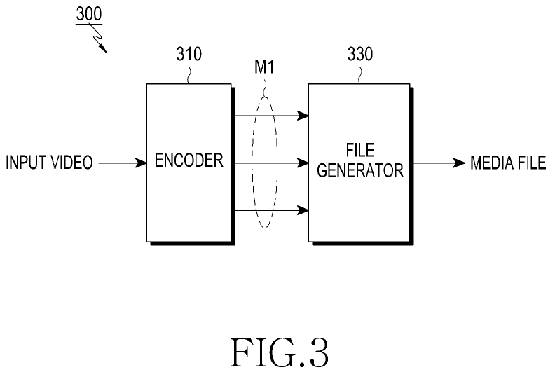

FIG. 3 is a diagram illustrating a media file generating device for multilayer videos according to an embodiment of the present invention.

The media file generating device 330 of FIG. 3 includes an encoder 310 for encoding an input video and outputting bitstreams M1 of multilayer videos and a file generator 330 for generating the bitstreams M1 of the multilayer videos to a media file containing information on the multiple tracks divided into the base layer and at least one enhancement layer and media data of each layer video as illustrated in FIG. 1B. The encoding device of FIG. 2 may be used as the encoder 310. However, various encoding devices capable of encoding multilayer videos, in addition to the encoding device of FIG. 2, may be used as the encoder 310. A detailed structure of the media file proposed in the present invention will be described later.

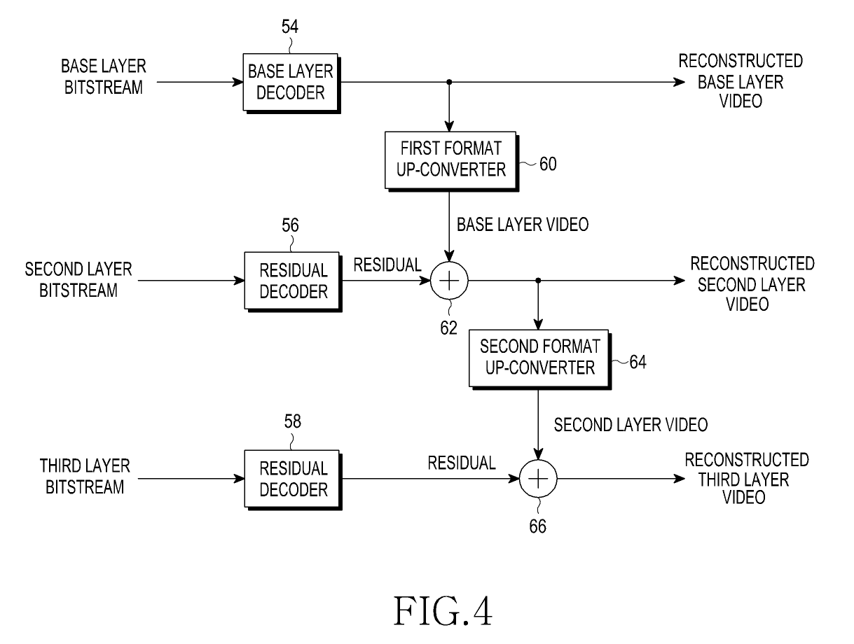

FIG. 4 is a diagram illustrating a multilayer video decoding device according to an embodiment of the present invention, and illustrates an example of the construction of the video decoding device for decoding the three layer video including one base layer and two enhancement layers. However, the present invention is not limited to the decoding device of FIG. 4, and the media file of the present invention may be applied to multilayer videos including at least two layers.

The multilayer video decoding device of FIG. 4 decodes the base layer bitstream through an existing standard video codec and restores the base layer video. Further, the multilayer video decoding device of FIG. 4 decodes the second layer bitstream through a residual codec and combines a decoded second layer residual video with a video obtained through format up-converting the restored base layer video, to restore the second layer video. Further, the multilayer video decoding device of FIG. 4 decodes the third layer bitstream through a residual codec and combines a decoded third layer residual video with a video obtained through format up-converting the restored second layer video, to restore the third layer video.

A process of the decoding will be described with reference to FIG. 4 in detail.

Referring to FIG. 4, a base layer decoder 441 decodes the base layer bitstream and restores the base layer video. The base layer decoder 441 may use an existing standard video codec, such as VC-1, H.264, MPEG-2, and MPEG-4. A residual decoder 443 decodes a second layer bitstream to output the residual video. An operation of decoding the second layer bitstream to output the residual video may be understood through the description of the residual encoding process of FIG. 2. That is, referring to the description of FIG. 2, the second layer bitstream generated in the residual encoder 223 is obtained through the encoding of the residual video output from the first residual unit 221. Accordingly, through the residual decoding of the second layer bitstream, the residual video of the second layer may be obtained.

Referring to FIG. 4 again, a first combiner 449 combines the residual video of the second layer with a video obtained through format up-converting the decoded base layer video through the format up-converter 447, to restore the second layer video.

Further, a residual decoder 445 of FIG. 4 decodes the third layer bitstream, to output a residual video of the third layer. A second combiner 453 combines the residual video of the third layer with a video obtained through format up-converting through the second format up-converter 451, to restore the third layer video. For example, the third layer video may be a HiFi video.

In the embodiment of FIG. 4, the example of the construction of the decoding apparatus for decoding the multilayer video bitstreams including the base layer bitstream, the second layer bitstream, and the third layer bitstream and outputting each corresponding layer video has been described. However, the construction of the decoding apparatus may decode the multilayer videos including at least two layers through the aforementioned method.

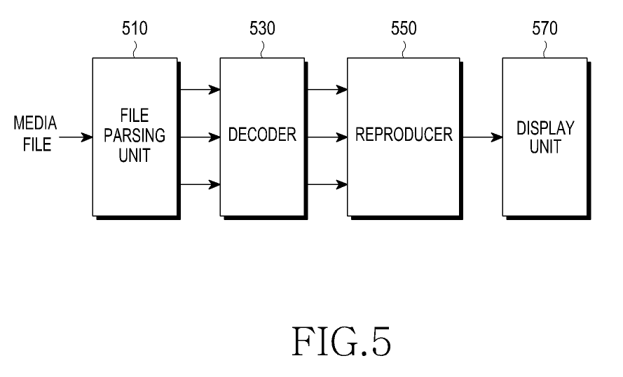

FIG. 5 is a diagram illustrating a media file reproducing device for multilayer videos according to an embodiment of the present invention.

The media file reproducing device of FIG. 5 includes a file parsing unit 510, a decoder 530, a reproducer 550, and a display unit 570.

The file parsing unit 510 receives and analyzes a media file containing information on the multiple tracks divided into the base layer and at least one enhancement layer and media data of each layer video, to extract each layer video. Referring to FIG. 1B, the file parsing unit 510 extracts reference information between tracks, as well as base information and a reproduction method of each base layer video and at least one enhancement layer video, from the base track 151 and the enhancement tracks 153 and 155 of the movie box 110 of the media file, and extracts media data (bitstream) of each layer from the media data box 170 based on the extracted information.

The decoder 530 decodes the bitstreams of the multilayer videos output from the file parsing unit 510 and restores videos of the base layer and at least one enhancement layer. The decoding device of FIG. 4 may be used as the decoder 530. However, various decoding devices capable of decoding multilayer videos, in addition to the decoding device of FIG. 4, may be used as the decoder 530. Further, the reproducer 550 reproduces each layer video output through the decoder 530 through the display unit 570. In this case, the reproducer 550 may output only video selected from the multilayer videos according to a key input or a determined control. Further, the decoder 530 may decode only video selected from the multilayer videos under a control of the reproducer 550.

The file parsing unit 510, the decoder 530, and the reproducer 550 of FIG. 5 may be implemented with at least one processor or a controller. Although it is not illustrated, the media file reproducing device may include a storage unit, such as a memory, for storing each decoded layer video. Further, the media file having the structure according to the embodiment of the present invention may be non-transitorily stored in a computer readable recording medium. The computer readable recording medium may be included in the devices of FIGS. 3 and 5 or used as a separate storage means.

Hereinafter, the structure of the media file according to the embodiment of the present invention will be described in detail.

The structure of the media file to be described supports multilayer videos of a base layer bitstream and an enhancement layer bitstream generated by different codecs. That is, it is assumed in the embodiment of the present invention that a codec of the base layer is basically different from a codec of a higher layer. For example, the codec of the enhancement layers may be a residual encoding codec, and the code of the base layer may be an existing predetermined codec. Further, the structure of the media file of the present invention maintains compatibility with the ISO base media file format regulated under the ISO/IEC 14496-12 standard.

First, an item of a compatible brand (compatible_brands) in a file type box of the media file of the present invention may contain a brand corresponding to a codec used in the enhancement layer. For example, VC-4 codec, which is well known as a type of the compatible codec may be used. Further, if the media file does not support the media file format proposed in the embodiment of the present invention but supports the existing ISO base file format corresponding to the codec used in the base layer, an item of a brand (compatible_brands) compatible with the corresponding ISO base file format may be included in the file type box (ftyp box, not shown) such that the media data of the base layer may be reproduced.

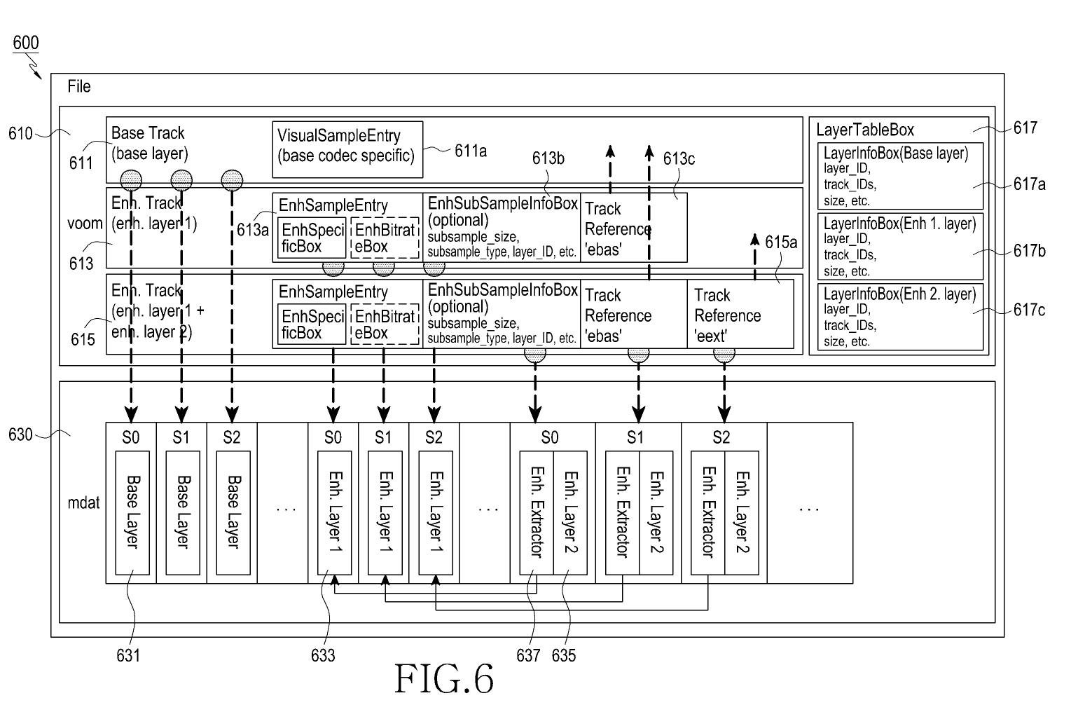

FIG. 6 is a diagram specifically illustrating a format of a media file according to an embodiment of the present invention, and specifically illustrates the format of the ISO base file 100b of FIG. 1B.

Referring to FIG. 6, a media file 600 includes a movie box (moov box) 610 for storing header information necessary for reproduction of media data and a media data box (mdat box) 630 for storing the media data. The header information contains basic information and information on a reproduction method of corresponding media data as illustrated with reference to FIG. 1B.

In FIG. 6, the movie box (moov box) 610 includes a base track 611 for storing basic information and a reproduction method of a base layer video and one or more enhancement tracks 613 and 615 for storing basic information and a reproduction method of an enhancement layer video. Although it is not illustrated, the tracks 611, 613, and 615 are distinguished using unique track identifiers (track ID) indicated in track header boxes (tkhd box). FIG. 6 illustrates an example of the format of the media file in which the movie box 610 includes the one base track 611 and the two enhancement tracks 613 and 615, and the actual number of enhancement tracks may be the number of supported enhancement layers.

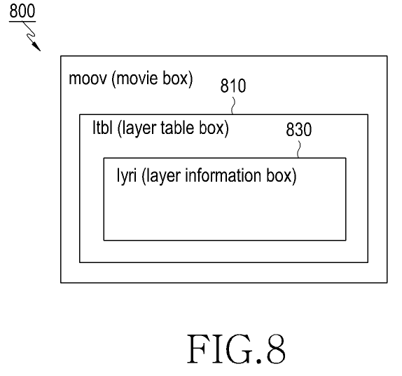

As illustrated in FIG. 1B, the media file proposed in the present invention, i.e. the ISO base file 100b, includes a bitstream 171 of a single base layer video and bitstreams 173 and 175 of one or multiple enhancement layer videos within the media data box 170. In order to clearly describe the relation between the layers of the multiple bitstreams, new boxes within the media file are defined in the present invention. The new boxes represent the relation between the layers included in the media file. For example, referring to FIG. 8, a movie box (moov box) 800 includes a layer table box (ltbl box) 810 and the layer table box (ltbl box) includes a layer information box (lyri box) 830 in order to describe the relation between the layers. Here, the movie box 800 of FIG. 8 corresponds to the movie box 610 of FIG. 6, and the layer table box (ltbl box) 810 and the layer information box (lyri box) 830 correspond to the layer table box 617 and the layer information boxes 617a, 617b, and 617c of FIG. 6, respectively.

Hereinafter, the layer table box (ltbl box) 810 and the layer information box (lyri box) 830 will be described in more detail.

First, an example of a syntax of the layer table box (ltbl box) 810 is represented as <syntax 1> below.

<syntax 1>

```
class LayerTableBox extends Box(‘ltbl’) {
        unsigned int(8) layer_count;
        for ( i=1; i <= layer_count; i++) {
                LayerInfoBox( );
        }
}
```

The layer table box (ltbl box) 810 includes a layer count (layer_count) and a layer information box (layerinfobox). The layer count represents the number of total layers including the base layer and the enhancement layers included in the media file. The layer information box (LayerInfoBox) corresponds to the layer information box (lyri box) 830 of FIG. 8, and as many layer information boxes (LayerInfoBox) as the number indicated by the layer count are included in the layer table box (ltbl box) 810.

An example of information construction of the enhancement information box (lyri box) 830 is represented as <syntax 2> below.

<syntax 2>

```
class LayerInfoBox extends FullBox(‘lyri’, version = 0, 0) {
        unsigned int(8) layer_ID;
        signed int(8) ref_layer_ID;
        unsigned int(8) track_count;
        unsigned int(32)[track_count] track_ID;
        unsigned int(3) reserved = 0;
        unsigned bit(1) quality_refinement_flag;
        if (quality_refinement_flag == 1) {
                unsigned int(4) max_quality_layer_ID;
        }
        else {
                unsigned int(4) reserved = 0;
        }
        unsigned int(8) [4] scalability;
        unsigned int(16) width;
        unsigned int(16) height;
        unsigned int(32) framerate;
        unsigned int(32) maxBitrate;
        unsigned int(32) avgBitrate;
}
```

Each layer and each layer information box (lyri box) 830 in <syntax 2> are mapped with each other by the layer identifier (layer_ID), and the layer identifier (layer_ID) has a unique value allocated to each layer. A reference layer identifier (ref_layer_ID) is a layer identifier (layer_ID) of a layer to which a corresponding layer refers, a track count (track_count) is the number of tracks included in the corresponding layer, and a track identifier (track_ID) is an arrangement of track identifiers included in the corresponding layer. In the present invention, the layer included in each track is indicated by using the exemplified information in the layer information box (lyri box) 830, so that the enhancement track may be constructed in various forms. Further, a quality refinement flag (quality_refinement_flag) represents a quality refinement, i.e. the number of quality refinement layers refined from a quality layer and used in the corresponding layer. Further, a maximum quality layer identifier (max_quality_layer_ID) represents the number of the quality layers in the corresponding layer.

Further, a scalability in <syntax 2> represents a character string for providing information on a scalable method between a current layer and a next lower layer. An example of the character string defined in the embodiment of the present invention is represented in Table 1.

TABLE 1

| | Character | |
|---|---|---|
| Name | string | Explanation |
| Base layer | ‘base’ | Used in a base layer without a lower |
| | | layer |
| SNR scalability | ‘snrs’ | SNR scalability exists between a lower |
| | | layer and a corresponding layer. |
| Spatial scalability | ‘spls’ | Spatial scalability exists between a |
| | | lower layer and a corresponding layer. |

Further, width, height, framerate, maxBitrate, and avgBitrate mean a width, a frame rate, a maximum bit rate, and an average bit rate of the corresponding layer video, respectively.

Referring to FIG. 6 again, the enhancement tracks 613 and 615 in the media file of FIG. 6 include one or multiple enhancement layers.

Referring to FIG. 6, in order to describe the number of enhancement layers included in each of the enhancement tracks 613 and 615 and characteristics of each of the enhancement tracks 613 and 615, for example, an enhancement sample entry (EnhSampleEntry) 613a, in which an enhancement specific box (EnhSpecificBox) and an enhancement bit rate box (EnhBitRateBox) are additionally defined in items of a visual sample entry (VisualSampleEntry) defined in the ISO base media file format of ISO/IEC 14496-12 as represented as <syntax 3> below, is included in each of the enhancement tracks 613 and 615

<syntax 3>

```
class EnhSampleEntry extends VisualSampleEntry ( ) {
        EnhSpecifixBox( );
        EnhBitRateBox( ); // optional
}
```

An example of information construction of the enhancement specific box (EnhSpecificBox) is represented as <syntax 4> below. The enhancement bit rate box (EnhBitRateBox) means a bit rate of the corresponding enhancement layer, and may be optionally included.

<syntax 4>

```
class EnhSpecificBox extends Box (‘esbx’) {
        unsigned int(8) layer_count;
        EnhDecSpecLayerStruc [layer_count] DecSpecificLayerInfo;
}
```

In <syntax 4>, a layer count (layer_count) refers to the number of enhancement layers included in the corresponding enhancement track, and as many enhancement layer characteristic information (EnhDecSpecLayerStruc) as the number indicated in the layer count (layer_count) is included in the corresponding enhancement track such that it is discriminated according to an identifier of the corresponding enhancement layer. The enhancement layer characteristic information (EnhDecSpecLayerStruc) contains a layer identifier (layer_ID) of at least one enhancement layer included in the corresponding enhancement track and information on a profile and a level used in a codec for encoding the corresponding layer, and a construction of the enhancement layer characteristic information (EnhDecSpecLayerStruc) is represented as <syntax 5> below.

<syntax 5>

```
class EnhDecSpecLayerStruc {
        unsigned int(8) layer_ID;
        unsigned int(3) profile;
        unsigned int(4) level;
        unsigned bit(1) cbr;
        unsigned int(16) sequence_header_length;
        bit(8*sequence_header_length) sequence_header;
}
```

In <syntax 5>, cbr(constant bit rate) indicates whether a constant bit rate or a different bit rate is applied to contents, i.e. the video. A sequence header (sequence_header) includes a sequence header of a layer corresponding to a layer identifier, and a length of a sequence header refers to a length of the sequence header of the layer corresponding to the layer identifier.

Further, the enhancement track proposed in the embodiment of the present invention may include one or multiple track reference boxes (Track reference Box). Specifically, in order to clearly indicate a relation between each enhancement track and other relevant tracks, three types of track reference for the enhancement track are defined as represented in Table 2.

TABLE 2

| Reference type | Explanation |
|---|---|
| ‘ebas’ | It is included in all enhancement tracks, and used for |
| | reference of a base track in a corresponding enhancement |
| | track. |
| ‘eext’ | It is used for reference of another enhancement track |
| | including original bit stream to be copied to a |
| | corresponding enhancement track. |
| ‘edep’ | It is used for reference of another enhancement track |
| | necessary for decoding a sample of a corresponding |
| | enhancement track. |

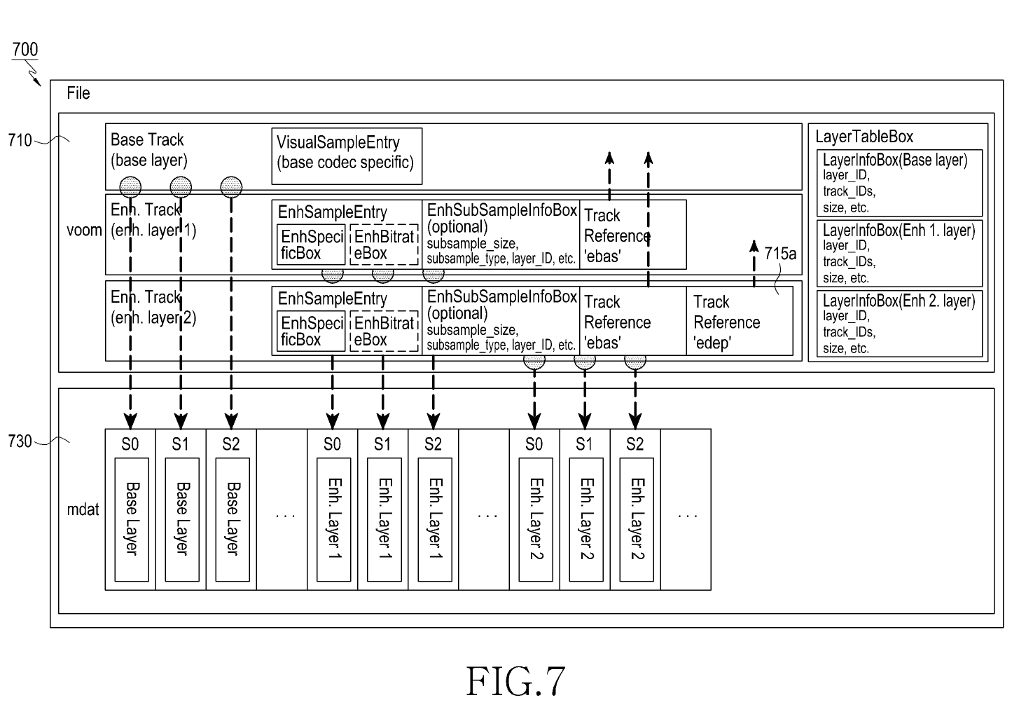

In the three types of track reference boxes in Table 3, ‘ebas’ and ‘eext’ correspond to reference numbers 613c and 615a in FIG. 6, and ‘edep’ corresponds to reference number 715a of FIG. 7.

FIG. 7 is a diagram specifically illustrating a format 700 of a media file according to another embodiment of the present invention. A media file 700 of FIG. 7 includes a movie box (moov box) 710 and a media data box (mdat box) 730 likewise to the media file 600 of FIG. 6. The construction of FIG. 7 identical to that of FIG. 6 will be omitted for convenience's sake. In the example of the media file 700 of FIG. 7, the enhancement track includes the track reference boxes including ‘edep’ (715a), which is information for reference of another enhancement track necessary for decoding a sample of a corresponding track, as well as ‘ebas’ and ‘eext’.

Referring to FIG. 6 again, the media data box (mdat box) 630 includes sample data of the base layer and sample data 633 and 635 of one or multiple enhancement layers. A single enhancement layer may be divided again to multiple quality layers according to a quality of sample data using a sub sample according to the used codec. Further, in order to divide the sample data 633 and 635 of the enhancement tracks 613 and 615 into multiple quality layers (or refinement layers), a new sub sample information box (SubSampleinformationBox) is constructed through adding information of Table 3 to a sub sample information box (SubSampleInformationBox) defined in the ISO base media file format of ISO/IEC 14496-12 as indicated with reference number 613b. The new sub sample information box (SubSampleinformationBox) clearly describes a characteristic of a sub sample (sub-sample) for dividing sample data included in the enhancement track including the multiple enhancement layers according to a quality for the data.

TABLE 3

| Name | Explanation |
|---|---|
| Type of sample | Type of a sub sample |
| (subsample_type) | |
| Layer identifier | Identifier (ID) of a layer to which a sub sample |
| (layer_ID) | belongs |
| Quality layer identifier | Identifier (ID) of a quality layer (i.e. refinement |
| (quality_layer_ID) | layer) to which a sub sample belongs |

Reference number 637 in FIG. 6 denotes an enhanced extractor for reference of samples of different enhancement layers in the enhancement track 615 including two or more enhancement layers. Information on the enhanced extractor 637 is stored in the media data box (mdat box) 630 in a unit of a sample together with the corresponding sample data.

What is claimed is:

1. A method of generating a media file for multilayer videos in a multimedia system, the method comprising:
encoding an input video and generating bitstreams of multilayer videos; and
receiving the bitstreams of the multilayer videos and generating a media file including information on multiple tracks, which are divided into a base layer and one or more enhancement layers, and media data of a video of each layer.

2. The method as claimed in claim 1, wherein at least one of the information on the multiple tracks contains layer table information in which a relation between layers is defined.

3. The method as claimed in claim 1, wherein the information on the multiple tracks contains characteristic information on each corresponding layer.

4. The method as claimed in claim 1, wherein generating of the media file comprises inserting the information on the multiple tracks in a movie box corresponding to header information of the media file.

5. The method as claimed in claim 1, wherein generating of the media file comprises inserting compatibility information on at least one codec used in the base layer and the one or more enhancement layers in a movie box corresponding to header information of the media file.

6. The method as claimed in claim 1, wherein generating of the media file comprises inserting layer information on the base layer and the one or more enhancement layers in a movie box corresponding to header information of the media file such that the layer information is discriminated from the information on the multiple tracks.

7. The method as claimed in claim 6, wherein the layer information contains at least one of information on a number of total layers, a layer identifier of each layer, information on another layer to which each layer refers, and information on a track including each layer.

8. The method as claimed in claim 7, wherein the layer information is inserted in the movie box such that the layer information corresponds to each layer of the base layer and the one or more enhancement layers.

9. The method as claimed in claim 1, wherein generating of the media file comprises inserting track reference information, which contains at least one of information indicating that a referred track is a track including a base layer, information indicating that a referred track is required for reproduction of a referring track, and information indicating that a bitstream is to be copied from a referred track, in each track information.

10. The method as claimed in claim 1, wherein generating of the media file comprises configuring track information on the one or more enhancement layers with one or more enhancement tracks, and
some of the one or more enhancement tracks include characteristic information on multiple enhancement layers.

11. The method as claimed in claim 10, further comprising inserting at least one of a type of sub sample and layer information for dividing samples included in the enhancement track including the characteristic information on the multiple enhancement layers for each layer in a corresponding enhancement track.

12. The method as claimed in claim 1, wherein a bitstream of the base layer is generated in a format of the media file compatible to an ISO base media file format.

13. An apparatus for generating a media file for multilayer videos in a multimedia system, the apparatus comprising:
an encoder for encoding an input video and generating bitstreams of multilayer videos; and
a file generator for receiving the bitstreams of the multilayer videos and generating a media file including information on multiple tracks, which are divided into a base layer and one or more enhancement layers, and media data of a video of each layer.

14. The apparatus as claimed in claim 13, wherein at least one of the information on the multiple tracks contains layer table information in which a relation between layers is defined.

15. The apparatus as claimed in claim 13, wherein the information on the multiple tracks contains characteristic information on each corresponding layer.

16. The apparatus as claimed in claim 13, wherein the file generator inserts the information on the multiple tracks in a movie box corresponding to header information of the media file.

17. The apparatus as claimed in claim 13, wherein the file generator inserts compatibility information on at least one codec used in the base layer and the one or more enhancement layers in a movie box corresponding to header information of the media file.

18. The apparatus as claimed in claim 13, wherein the file generator inserts layer information on the base layer and the one or more enhancement layers in a movie box corresponding to header information of the media file such that the layer information is discriminated from the information on the multiple tracks.

19. The apparatus as claimed in claim 18, wherein the layer information contains at least one of information on a number of total layers, a layer identifier of each layer, information on another layer to which each layer refers, and information on a track including each layer.

20. The apparatus as claimed in claim 19, wherein the layer information is inserted in the movie box such that the layer information corresponds to each layer of the base layer and the one or more enhancement layers.

21. The apparatus as claimed in claim 13, wherein the file generator inserts track reference information, which contains at least one of information indicating that a referred track is a track including a base layer, information indicating that a referred track is required for reproduction of a referring track, and information indicating that a bitstream is to be copied from a referred track, in each track information.

22. The apparatus as claimed in claim 13, wherein the file generator configures track information on the one or more enhancement layers with one or more enhancement tracks, and some of the one or more enhancement tracks include characteristic information on multiple enhancement layers.

23. The apparatus as claimed in claim 22, wherein the file generator further inserts at least one of a type of sub sample and layer information for dividing samples included in the enhancement track including the characteristic information on the multiple enhancement layers for each layer in a corresponding enhancement track.

24. The method as claimed in claim 13, wherein a bitstream of the base layer is generated in a format of the media file compatible to an ISO base media file format.

25. A terminal apparatus for reproducing a media file in a multimedia system, the terminal comprising:
a display unit for displaying a media file;
a decoder for decoding multilayer videos including a base layer and one or more enhancement layers; and
a controller for making a control such that a media file including information on multiple tracks of the multilayer videos and media data of a video of each layer is analyzed, at least one layer video is extracted, the extracted layer video is restored in the decoder, and the restored layer video is displayed through the display unit.
